(19) United States
(12) Patent Application Publication
(10) Pub. No.: US 2023/0346642 A1
(43) Pub. Date: Nov. 2, 2023

(54) CONTAINER COMPRISING A BODY WITH A MARKING ELEMENT AND A METHOD FOR PRODUCING A CONTAINER

(71) Applicant: SCHOTT Pharma AG & Co. KGaA, Mainz (DE)

(72) Inventors: Oliver Sohr, Mainz (DE); Bernhard Hunzinger, Wackernheim (DE); Florian Maurer, Griesheim (DE); Peter Thomas, Koblenz (DE)

(73) Assignee: SCHOTT Pharma AG & Co. KGaA, Mainz (DE)

(21) Appl. No.: 18/351,153

(22) Filed: Jul. 12, 2023

Related U.S. Application Data
(62) Division of application No. 17/088,191, filed on Nov. 3, 2020.

(30) Foreign Application Priority Data
Nov. 4, 2019 (EP) 19207009.2

(51) Int. Cl. A61J 1/14; B65D 1/40

(52) U.S. Cl. CPC A61J 1/1468; B65D 1/40; A61J 2205/40; B65D 2203/12

(57) ABSTRACT

A method for producing a container includes identifying a location at a body, with the body at this location having a stress parameter which has a value less than or equal to a threshold value. The identifying includes deriving the threshold value from a simulation result of a simulation based on a finite element method of the stress parameter for a surface area and/or a volume area of the body with or without a marking element present, the identifying also includes obtaining a mean value by the simulation for the stress parameter for at least a part of at least one of the surface area or the volume area of the body. The threshold value is a sum of the mean value and 1000 % or less of an absolute value of the mean value. A marking element is provided which allows identification of the container at the identified location.

### CROSS REFERENCE TO RELATED APPLICATIONS

This application is a division of U.S. Pat. Application Serial No. 17/088,191, entitled “CONTAINER COMPRISING A BODY WITH A MARKING ELEMENT AND A METHOD FOR PRODUCING A CONTAINER,” filed on Nov. 3, 2020, which is incorporated in its entirety herein by reference. U.S. Pat. Application Serial No. 17/088,191 claims priority to European Patent Application No. 19207009.2 filed Nov. 4, 2019, which is incorporated in its entirety herein by reference.

### BACKGROUND OF THE INVENTION

### 1. Field of the Invention

The present invention relates to a container for holding at least one pharmaceutical composition including a body which has at least one marking element and to a method for producing such a container.

### 2. Description of the Related Art

In the state of the art, containers for holding pharmaceutical compositions such as vials, syringes, cartridges and the like are well known. For such containers it is often required to have a way which allows identification of each single container among others. This can be important, for example, for the purpose of an automation of handling the containers during filling, routing, storing, dispatching as well as for ensuring quality and safety standards, which often put high demands on the traceability of each container during its lifetime cycle. Often said identification ways are designed in form of a marking element which is then used in order to fulfill the mentioned requirements.

So far, often a label has been glued on each container and a unique identification code such as a barcode is printed on the label. In other applications the unique identification code has been transferred directly on the container by a printing process using ink. Thus, both approaches require a printed code. By reading the respective unique identification code, the container can be identified once a link between the container and the unique identification code has been established.

However, gluing labels on the surface or using a printer is often slow and complicated during use, hence often representing a bottle neck in the production line. The size of these printed codes is usually limited by the printing method and cannot be reduced sufficiently in order to create the required small codes. Particularly for small containers, it is hard or even not possible to provide a sufficiently large area to glue a label onto. Often containers exhibit a complex geometry, which makes it difficult to use labels or printers for the purpose of providing an identification code on them.

Furthermore, it turns out that during further handling or use of the containers there is a risk that the labels of the containers peel off or that codes printed directly on the containers using ink vanish, if the containers are exposed to water or other extreme conditions. In addition, it also turns out that it is a general problem that codes provided by these known techniques are subject to fading over time.

These drawbacks lead to the situation that containers which cannot be identified anymore have to be disposed, either because the labels have been completely lost or because they are no longer readable. This is especially the case in the pharmaceutical field where it is not tolerable that substances of unknown identification are in use. However, particularly in this field, disposing containers containing respective compositions is quite expensive. Apart from that, sorting out containers whose identification is unclear might lead to downtimes of the system or at least requires extra resources. In any event, using such conventional marking elements might lead to increased service costs.

An even more serious scenario is an incorrect identification and subsequent incorrect assignment of a container due to a vanishing unique identification code. In the worst case, this might lead to serious health risks of the patient.

In the art, it is also known to use techniques for graving information such as a marking element directly in the surface of a container, for example by laser ablation techniques or the like. A marking element provided in that way on the container would indeed be cheap in the production process and would have further advantages with respect to durability and reliability. However, for glass containers, such as glass vials, used in the pharmaceutical industry, axial compression and side compression have been identified as common and typical load situations during handling, processing and transportation. This, however, requires that the container must be sufficiently robust to withstand such typical loads. Since marking elements graved in the surface represent a damage of the container, such marking elements are usually not taken into consideration for respective applications where the containers are subject to said loads.

### SUMMARY OF THE INVENTION

Exemplary embodiments provided according to the present invention provide a container having a marking element which is on the one hand easy and cheap to produce but on the other hand still reliable, durable and fail safe and which is particularly suitable for a wide range of containers with respect to size and geometry. Some exemplary embodiments provided according to the present invention provide a method for producing a container having such a marking element.

In some exemplary embodiments provided according to the present invention, a container for holding at least one pharmaceutical composition includes: a body having at a location a marking element that allows identification of the container. At least one stress parameter of the body has a value less than or equal to a threshold value at the location. The threshold value is at least one of derived or derivable from a simulation result of a simulation based on a finite element method of the at least one stress parameter for at least one of a surface area or a volume area of the body with or without the marking element present. A mean value is obtained or is obtainable by the simulation for the at least one stress parameter for at least a part of at least one of the surface area or the volume area of the body. The threshold value is the sum of the mean value and 1000 % or less of an absolute value of the mean value.

In some exemplary embodiments provided according to the present invention, a container for holding at least one pharmaceutical composition includes a body having at a location a marking element that allows identification of the container. At the location at least one stress parameter of the body has a value less than or equal to a threshold value. The threshold value is a fixed value of 300 MPa or less.

In some exemplary embodiments provided according to the present invention, a method for producing a container for holding at least one pharmaceutical composition includes: providing a body; identifying a location at the body, with the body at this location having at least one stress parameter which has a value less than or equal to a threshold value, the threshold value being at least one of derived or derivable from a simulation result of a simulation based on a finite element method of the at least one stress parameter for at least one of a surface area or a volume area of the body with or without a marking element present, a mean value is obtained or is obtainable by the simulation for the at least one stress parameter for at least a part of at least one of the surface area or the volume area of the body, the threshold value is a sum of the mean value and 1000 % or less of an absolute value of the mean value; and providing a marking element which allows identification of the container at the identified location.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows an illustration of a container having at the bottom a marking element provided according to the present invention;

FIGS. 2A-2C show different exemplary marking elements graved into glass;

FIG. 3A shows an illustration of a setup for an axial compression test;

FIG. 3B shows an exemplary contour plot of the stress distribution on an outer surface of a specimen under the axial compression test;

FIG. 4A shows an illustration of a setup for a side compression test;

FIG. 4B shows an exemplary contour plot of the stress distribution on an outer surface of a specimen under the side compression test;

FIG. 5 shows a perspective cut-view of a model of a vial having different parts;

FIG. 6A shows a contour plot of the stress distribution of the vial shown in FIG. 1 under axial compression;

FIG. 6B shows a contour plot of the stress distribution of the cylindrical wall of the vial shown in FIG. 1 under axial compression;

FIG. 6C shows a contour plot of the stress distribution of the heel of the vial shown in FIG. 1 under axial compression;

FIG. 6D shows a contour plot of the stress distribution of the bottom of the vial shown in FIG. 1 under axial compression;

FIG. 7A shows a contour plot of the stress distribution of the vial shown in FIG. 1 under side compression;

FIG. 7B shows a contour plot of the stress distribution of the cylindrical wall of the vial shown in FIG. 1 under side compression;

FIG. 7C shows a contour plot of the stress distribution of the heel of the vial shown in FIG. 1 under side compression;

FIG. 7D shows a contour plot of the stress distribution of the bottom of the vial shown in FIG. 1 under side compression; and

FIG. 8 shows a flow chart of a method provided according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

In some exemplary embodiments provided according to the present invention, a container for holding at least one pharmaceutical composition is provided. The container includes a body. The body includes at at least one location at least one marking element, which allows identification of the container. At said location, at least one stress parameter of the body has a value less than or equal to at least one threshold value. The at least one threshold value is derived and/or derivable from at least one simulation result of at least one simulation based on a finite element method of the stress parameter for at least one surface and/or volume area of the body with or without the marking element present. At least one mean value is or can be obtained by the simulation for the stress parameter for at least a part of the surface and/or volume area of the body. The threshold value is the sum of the mean value and 1000 % or less of the absolute value of the mean value.

Exemplary embodiments provided according to the present invention are thus based on the surprising finding that a marking element can be provided on the container, such as on the body, also by techniques which lead to a weakening of the material, for example due to material ablation, if the location of the marking element is chosen such that for the location of the marking element one or more stress parameters are restricted to a certain threshold value. Locations fulfilling this criterion can be used for permanently graving the marking element into the container while still ensuring a high strength of the container irrespective of the damages the marking element represents in the structure of the body.

At the same time, it has been found that the threshold value can be defined in a general and universally valid manner if it is set in relation to the outcome of a simulation of stress parameters of the respective container which carries the marking element. This leads to the advantageous situation that embodiments and techniques provided according to the present invention can be applied to all kinds of containers even if they have completely different geometries, shapes, sizes and materials since only a simulation model is required. Hence, the approach can be applied in a very flexible and universal manner.

Indeed, since products today are usually designed using respective three-dimensional models, there are no extra costs with respect to setting up a respective model for conducting a simulation according to the present invention. This makes the approach even more interesting since it can be integrated easily in existing structures.

More precisely, it surprisingly turned out that obtaining a mean value of the respective stress parameter from the simulation is a quite reliable figure to establish the reference value to which the threshold value refers.

Overall, it is possible to use marking techniques such as laser ablating or etching for providing a marking element on a container (such as a body thereof). These techniques in turn enable production of very small marking elements and can even be used for complex geometries without any extensive modifications on the manufacturing process. This way, the container can be of comparably low cost while there remains a high design flexibility for the body. This is true because techniques such as laser processing are not limited to any surface geometries for providing the marking element.

Applying the principles of the present invention allows that the marking element is graved into the material of the body, thus, the marking element is furthermore very durable, hence, reliable and fail-safe. For the same reasons, there are also no problems with respect to fading, peeling off or vanishing of the marking element.

Further analysis revealed the surprising aspect that providing the marking element by removing material from the body at the identified location there is no severe loss, such as no loss, of strength for the entire container under load, although material is removed. Thus, although the material is weakened, the stability of the container is still ensured. In other words, the locations identified according to the present invention seem to be insensitive for damages caused by graving the marking element.

The analyses have also shown that, from a practical point of view, the locations identified based on the simulation results are stable no matter whether the simulation is run for a model container with or without the marking element. In other words, if a first simulation incorporating a model container without a marking element finally yields a certain location for the marking element based on the inventive concept, a second simulation incorporating a model container with a marking element at that location finally also yields that location for the marking element.

It is acknowledged that the simulation incorporated in the approach provided according to the present invention can be performed with any software tool which allows modelling the container to which the marking element should be applied to and which allows running a finite element analysis simulation for that model with respect to the stress parameter under investigation. For example, the commercially available software ABAQUS with the program version 2018 released on Nov. 7, 2017 by company DASSAULT Systems Simulia Corporation can be used to run these simulations the results of which then can be further used or which are used in the context of the present invention.

It is acknowledged that the mean value obtained by the simulation for the stress parameter can be any kind of mean value which is appropriate such as the average value or the average weighted value. It is acknowledged that when using the finite element analysis, the stresses are calculated for each node of an element of the mesh. Since the elements usually are of different size (for example the mesh of a vial has different sizes at the bottom and at the heel), the mean values of the stresses can be calculated weighted with a “logic element area” corresponding to that node. The person skilled in the art understands that the “logic element area” takes into account the percentage of the surface area which is assigned to the respective node. That means that, for example, the “logic element area” of a node might be larger for an edge compared to that of a corner, respectively, of the simulated model.

The person skilled in the art clearly understands that the “location” of the marking element might have some spatial extension. In some embodiments, it might have an extension in two dimensions or three dimensions. For example, a location of the marking element might be a surface area of certain size of the body on which the marking element is provided (for example by a laser ablation technique or etching or the like). Of course, if required, the location can also be understood as a three-dimensional volume element in which the marking element is provided.

It is in addition acknowledged that labels and ink might represent a potential source of contamination and, in addition, might produce small particles, which is not appropriate for clean room situations. Hence, using graved marking elements, also clean room conditions are met.

In some embodiments, the thickness of the container, such as the thickness of the bottom of the container, is between 0.6 and 1.7 mm.

In some embodiments, the depth of the marking element is graved into the surface, such as the outer surface, of the container with a depth of 1-2 µm.

In some embodiments, the depth of the marking element is graved into the surface, such as the outer surface, of the container with a depth less than 10 % of the thickness of the container, such as of the maximum thickness of the bottom of the container.

In some embodiments, the threshold value is the sum of the mean value and 900% of the absolute value of the mean value, is the sum of the mean value and 800% of the absolute value of the mean value, is the sum of the mean value and 700% of the absolute value of the mean value, is the sum of the mean value and 600% of the absolute value of the mean value, is the sum of the mean value and 700% of the absolute value of the mean value, is the sum of the mean value and 400% of the absolute value of the mean value, is the sum of the mean value and 300% of the absolute value of the mean value, is the sum of the mean value and 200% of the absolute value of the mean value or is the sum of the mean value, or 100% of the absolute value of the mean value.

In some embodiments, the container is a vial and the mean value is or can be obtained by the simulation for the stress parameter for at least a part of: the cylindrical walls of the vial, the bottom of the vial and/or the heel of the vial.

In some embodiments, the location of the marking element at the body is partially or completely within the surface and/or volume area of the body which is used for the simulation of the stress parameter.

In some embodiments, at said location the at least one stress parameter of the body has a value less than or equal to 90%, 80%, 70%, 60%, 50%, 40%, 30%, 20% or 10%, respectively, of the at least one threshold value.

In some embodiments, the combination of the following features are provided:

A container for holding at least one pharmaceutical composition, the container including a body that comprises at at least one location at least one marking element, which allows identification of the container. At said location, at least one stress parameter of the body has a value less than or equal to at least one threshold value. The threshold value is derived and/or derivable from at least one simulation result of at least one simulation based on a finite element method of the stress parameter for at least one surface area of the body with or without the marking element present. At least one mean value is or can be obtained by the simulation for the stress parameter for at least a part of the surface area of the body. The threshold value is the sum of the mean value and 1000 % or less of the absolute value of the mean value.

A container for holding at least one pharmaceutical composition, the container including a body that comprises at at least one location at least one marking element, which allows identification of the container. At said location, at least one stress parameter of the body has a value less than or equal to at least one threshold value. The threshold value is derived from at least one simulation result of at least one simulation based on a finite element method of the stress parameter for at least one surface area of the body with or without the marking element present. At least one mean value is or can be obtained by the simulation for the stress parameter for at least a part of the surface area of the body. The threshold value is the sum of the mean value and 1000 % or less of the absolute value of the mean value.

A container for holding at least one pharmaceutical composition. The container comprising a body that comprises at at least one location at least one marking element, which allows identification of the container. At said location, at least one stress parameter of the body has a value less than or equal to at least one threshold value. The threshold value is derivable from at least one simulation result of at least one simulation based on a finite element method of the stress parameter for at least one surface area of the body with or without the marking element present. At least one mean value is or can be obtained by the simulation for the stress parameter for at least a part of the surface area of the body. The threshold value is the sum of the mean value and 1000 % or less of the absolute value of the mean value.

A container for holding at least one pharmaceutical composition. The container comprising a body that comprises at at least one location at least one marking element, which allows identification of the container. At said location, at least one stress parameter of the body has a value less than or equal to at least one threshold value. The threshold value is derived and/or derivable from at least one simulation result of at least one simulation based on a finite element method of the stress parameter for at least one volume area of the body with or without the marking element present. At least one mean value is or can be obtained by the simulation for the stress parameter for at least a part of the volume area of the body. The threshold value is the sum of the mean value and 1000 % or less of the absolute value of the mean value.

A container for holding at least one pharmaceutical composition. The container comprising a body that comprises at at least one location at least one marking element, which allows identification of the container. At said location, at least one stress parameter of the body has a value less than or equal to at least one threshold value. The threshold value is derived from at least one simulation result of at least one simulation based on a finite element method of the stress parameter for at least one volume area of the body with or without the marking element present. At least one mean value is or can be obtained by the simulation for the stress parameter for at least a part of the volume area of the body. The threshold value is the sum of the mean value and 1000 % or less of the absolute value of the mean value.

A container for holding at least one pharmaceutical composition. The container comprising a body that comprises at at least one location at least one marking element, which allows identification of the container. At said location, at least one stress parameter of the body has a value less than or equal to at least one threshold value. The threshold value is derivable from at least one simulation result of at least one simulation based on a finite element method of the stress parameter for at least one volume area of the body with or without the marking element present. At least one mean value is or can be obtained by the simulation for the stress parameter for at least a part of the volume area of the body. The threshold value is the sum of the mean value and 1000 % or less of the absolute value of the mean value.

In some exemplary embodiments provided according to the present invention, a container for holding at least one pharmaceutical composition is provided. The container comprises a body that comprises at at least one location at least one marking element, which allows identification of the container. At said location, at least one stress parameter of the body has a value less than or equal to at least one threshold value. The threshold value is a fixed value of 300 MPa or less.

Exemplary embodiment provided according to the present invention are further based on the surprising finding that a marking element can be provided on the container, such as on the body, by techniques which lead to a weakening of the material, for example due to material ablation, if the location of the marking element is chosen such that for the location of the marking element one or more stress parameters are restricted to a certain threshold value. Locations fulfilling this criterion can be used for permanently graving the marking element into the container while still ensuring a high strength of the container irrespective of the damages the marking element represents in the structure of the body.

It has been found that for many practical aspects, it is a good estimation to set the threshold value to a fixed value. This approach allows to determine the location of the marking element in an easy and straight-forward manner based on a quite handy criterion while at the same time the approach has been proven to yield reliable results in practice.

Hence, even if no model of the container exists or if for other reasons no simulation results are available for the stress parameter, it is still possible to choose a location at the container for the marking element where it does not considerably affect the stability of the container.

For example, the fixed value might be based on empirical values which have been proven reliable in the past. Particularly, the fixed value is or can be derived from other experiments and/or analysis. For example, the fixed value is or can be derived from fractographic analysis of containers which are broken due to an applied force at the location of the marking element.

For example, fixed values obtained from a first fractographic analysis of a plurality of sample containers are between 70 MPa and 235 MPa.

For example, fixed values obtained from a second fractographic analysis of a plurality of sample containers are between 80 MPa and 280 MPa.

With respect to the further advantages arising from choosing the location dependent on the stress parameter, reference is made to the description provided previously.

In some exemplary embodiments provided according to the present invention, a first plurality of glass containers is provided. Each glass container has a body which comprises as body parts:
i) a glass tube with a first end and a further end, the glass tube defining a longitudinal axis L_{tube} and comprises, in a direction from the top to the bottom:
ia) a top region that is located at the first end of the glass tube, the outer diameter of the top region being dt;
ib) a junction region that follows the top region;
ic) a neck region that follows the junction region, the outer diameter of the neck region being dn with dn < dt;
id) a shoulder region that follows the neck region; and
ie) a body region that follows the shoulder region and that extends to the further end of the glass tube, the thickness of the glass in the body region being lb and the outer diameter of the body region being db with db > dt; and
ii) a glass bottom that closes the glass tube at the further end.

At least one marking element is graved into at least one surface of at least one body part. The load under which 50 % of the glass containers contained in the first plurality of glass containers break under axial compression or side compression in the axial compression test or side compression test as described herein is at least 1200 N for axial compression and 900 N for side compression. The load under which 50 % of a second plurality of glass containers contained in the second plurality of glass containers break under axial compression or side compression in the axial compression test or side compression test as described herein is at least 1200 N for axial compression and 900 N for side compression. The glass containers of the second plurality of glass containers are identical to the glass containers of the first plurality of glass containers with the exception of lacking a marking element. The number of glass containers comprised by the first plurality of glass containers is identical to the number of glass containers comprised by the second plurality of glass containers.

Exemplary embodiments provided according to the present invention are thus based on the surprising finding that a marking element can be provided on the container, such as on the body, by techniques which lead to a weakening of the material, for example due to material ablation, if the location of the marking element is chosen such that when assessing the probability that a container is broken under a certain predefined load there is statistically no considerable difference between a container having a marking element and a container having no marking element.

This approach allows providing a marking element for a container without having any disadvantages with respect to rejects due to broken containers.

Hence, this approach allows providing containers, such as vials, having a marking element and having the same strength and the same breaking behavior as identical containers without such a marking element.

In some embodiments, the stress parameter is at least one parameter of the group consisting of: first principle stress, mechanically induced tensile stress, mechanically induced compressive stress, thermally generated stresses and/or chemically generated stresses.

By choosing the stress parameter as mechanically induced tensile stress, the location can be chosen such that there is only a mechanically induced tensile stress which is below the threshold value. This has been found advantageous since especially for a container (or body) made of glass, the larger the tensile stresses are the more unstable the container is in the respective area. Hence, an area where the mechanically induced tensile stress does not exceed a certain value may be advantageous. For example, the threshold can be 100 MPa, hence, the mechanically induced tensile stress must be in this case within the range of 0 to 100 MPa (note that the mechanically induced tensile stress takes a positive value).

By choosing the stress parameter as mechanically induced compressive stress, the location can be chosen such that there is only a mechanically induced compressive stress which is below the threshold value. This has been found advantageous since especially for a container (or body) made of glass, the more negative the compressive stresses are, the more stable the container is in the respective area. Hence, an area may be chosen where the mechanically induced compressive stress does not exceed a certain value. For example, the threshold can be -50 MPa, hence, the mechanically induced compressive stress must be in this example within the range of -∞ to -50 MPa (note that the mechanically induced compressive stress takes a negative value; and since the threshold is negative, the range goes from minus infinity MPa to -50 MPa). The containers will usually not exhibit compressive stresses of less than -3,000 MPa, -2,000 MPa or -1,000 MPa.

By choosing the stress parameter as the first principle stress, a combined analysis can be conducted since, for a particular point on the surface of the object, the first principle stress is either compressive stress or tensile stress, depending on the sign. This allows a very realistic evaluation since the first principle stress allows consideration of both stress types. For example, it is possible to evaluate the mean value of a certain surface area with respect to the first principle stress. This mean value indicates whether tensile stresses or the compressive stresses are more present over the respective area: The more tensile stresses are present, hence contributing to the summation over the surface area, the more positive (or less negative) the mean value is and the more compressive stresses are present, the more negative (or less positive) the mean value is. This in turn might serve as a basis for determining the threshold value which can be, for example, the smaller, the smaller the mean value is. Indeed, for smaller threshold values, the marking element might also be graved more deeply into the surface.

If thermally generated stresses and/or chemically generated stresses are chosen as respective stress parameters, it is possible to take into account a special treatment of the container or body. Particularly, it is noted that tempering is always beneficial after a marking element has been provided on the container in order to reduce or eliminate stresses.

In some embodiments, the stress parameters are mechanically induced tensile stress and mechanically induced compressive stress.

In some embodiments, (i) the mechanically induced tensile stress is mechanically induced tensile stress during use; (ii) the mechanically induced compressive stress is mechanically induced compressive stress during use; (iii) the thermally generated stress is tensile stresses and/or compressive stresses, such as occurring in the body’s volume and/or surface; and/or (iv) the chemically generated stress is tensile stresses and/or compressive stresses, such as occurring in the body’s volume and/or surface.

This allows defining the stress parameter such that it is regarded under realistic conditions. This means, for example, during use (with respect to the mechanically induced stresses) or at the respective location where the stress occurs (with respect to the generated stresses). This in turn allows a more precise analysis, hence identifying a more reliable location for the marking element.

In some embodiments, the combination of the following features is provided: the mechanically induced tensile stress is mechanically induced tensile stress during use; the mechanically induced compressive stress is mechanically induced compressive stress during use; the thermally generated stress is tensile stresses, such as occurring in the body’s volume; the thermally generated stress is tensile stresses, such as occurring in the body’s surface; the thermally generated stress is compressive stresses, such as occurring in the body’s volume; the thermally generated stress is compressive stresses, such as occurring in the body’s surface; the chemically generated stress is tensile stresses, such as occurring in the body’s volume; the chemically generated stress is tensile stresses, such as occurring in the body’s surface; the chemically generated stress is compressive stresses, such as occurring in the body’s volume; and/or the chemically generated stress is compressive stresses, such as occurring in the body’s surface.

In some embodiments, the mechanically induced tensile stress is mechanically induced tensile stress during use and the mechanically induced compressive stress is mechanically induced compressive stress during use.

In some embodiments, at said location the stress parameter of the body has a value less than or equal to the threshold value under at least one state condition, wherein the simulation may be run under the state condition.

This allows conducting the analysis of the stress parameter under a more defined framework by setting certain environmental variables to a certain value. It is thus possible to improve the reliability and reproducibility of the stress parameter, hence improving the identified location for the marking element.

In some embodiments, the state condition comprises: (i) an ambient pressure of the body of 1 bar; and/or (ii) at least one force acting radially and/or axially on at least one part of the body, such as at the limit of the breaking strength of the body.

Defining the ambient pressure as state condition leads to a realistic scenario for many applications where containers are used. Furthermore, it allows reproducibility to a high degree.

Defining forces as state condition allows assessing the container under a definite scenario. For example, an extreme situation right before some event (such as breaking of the container) can be regarded. This in turn allows to obtain the locations which are suitable still under such extreme conditions.

In some embodiments, the combination of the following features is provided: the state condition comprises an ambient pressure of the body of 1 bar; the state condition comprises at least one force acting radially on at least one part of the body, such as at the limit of the breaking strength of the body; and/or the state condition comprises at least one force acting axially on at least one part of the body, such as at the limit of the breaking strength of the body.

In some embodiments, at least one force acting axially on the body at the limit of the breaking strength of the body.

In some embodiments, the fixed value is between 50 and 300 MPa, such as between 100 and 200 MPa, such as 150 MPa.

For different scenarios, such as for different loads (with respect to value and/or type) applied to the container during use, the fixed value might be adapted to reflect the situation more realistically.

In some embodiments, the fixed value is 150 MPa for tensile stress and the fixed value is -500 MPa for compressive stress.

In some embodiments, (i) each of two or more stress parameters of the body have a value less than or equal to respective two or more threshold values, such as under the same or at least in part different two or more state conditions, and/or (ii) the stress parameter of the body has a value less than or equal to two or more threshold values under at least in part different two or more state conditions.

It is, thus, possible that the location for the marking element is not only identified based on one single stress parameter but on two or even more stress parameters. For example, one might use the mechanically induced tensile stress as a first stress parameter and the mechanically induced compressive stress as a second stress parameter. In this case, it is furthermore possible to define either the same or two different threshold values. For example, one can define a first threshold value for the first stress parameter and a second threshold value for the second stress parameter where for example the second threshold value is less than the first threshold value (for example the second threshold value is negative, say -50 MPa, and the first threshold value is positive, say +100 MPa).

The same applies mutatis mutandis also to the state condition, if such one is defined. For example, the first and second stress parameter can be observed under the same state condition but also under a different one.

Accordingly, more than two stress parameters with one or more thresholds and with none or one or even more different state conditions can be defined.

It is acknowledged that, of course, at a single point of the surface of an object there is only either tensile stress or compressive stress. For example, the first principle stress might be evaluated in order to determine for each point whether it has a positive or a negative value for the first principle stress, corresponding, respectively, to tensile stress or compressive stress at that point. However, according to the present invention, it might be also possible to define an individual stress parameter which, for example, only provides values for tensile stresses or only for compressive stresses. For example, the values for such an individual stress parameter directed to the tensile stress might be obtained by keeping only the positive and zero values of the first principle stress while discarding negative values. Hence, points of the surface which are subject to compressive stress will not contribute to the evaluation of that individual stress parameter. Such individual stress parameters might be used as first or second stress parameters discussed above.

In cases where more than one state condition is used, the person skilled in the art understands that also a respective number of simulations might be incorporated. In some cases, a single simulation only is required for more than one stress parameter under the same state condition.

In every case, this leads to a highly flexible approach which can take into account many different aspects of the situation present and at the same time take benefits from the general teachings of the present invention.

In some embodiments, a first stress parameter is tensile stress and a second stress parameter is compressive stress under the same state condition of axial load applied to the container at the breaking limit. Respective first and second thresholds for the first and second stress parameter is obtained from a single simulation run under that state condition.

In some embodiments, the body (i) is designed at least in part as hollow body and/or as a tubular body; (ii) has at least one closed end, hast two open ends and/or has at least one opening; and/or (iii) has at least one inner surface which is or can be brought in contact with the pharmaceutical composition when the composition is held by the container and/or at least one outer surface which is not in contact with the composition when the composition is held by the container, the location of the marking element extending across at least one area of the inner and/or outer surface.

If the marking element extends across the outer and/or inner surface, it can be produced and read in an easy manner because the surface is directly accessible for writing and reading purposes.

In some embodiments, the following features are provided: the body is designed at least in part as hollow body; the body is designed at least in part as a tubular body; the body has at least one closed end; the body has two open ends; the body has at least one opening; the body has at least one inner surface which is in contact with the pharmaceutical composition when the composition is held by the container and at least one outer surface which is not in contact with the composition when the composition is held by the container, the location of the marking element extending across at least one area of the inner and/or outer surface; the body has at least one inner surface which is in contact with the pharmaceutical composition when the composition is held by the container, the location of the marking element extending across at least one area of the inner surface; the body has at least one outer surface which is not in contact with the composition when the composition is held by the container, the location of the marking element extending across at least one area of the outer surface; the body has at least one inner surface which can be brought in contact with the pharmaceutical composition when the composition is held by the container and at least one outer surface which is not in contact with the composition when the composition is held by the container, the location of the marking element extending across at least one area of the inner and/or outer surface; the body has at least one inner surface which can be brought in contact with the pharmaceutical composition when the composition is held by the container, the location of the marking element extending across at least one area of the inner surface; and/or the body has at least one outer surface which is not in contact with the composition when the composition is held by the container, the location of the marking element extending across at least one area of the outer surface.

In some embodiments, the body is designed as hollow tubular body with at least one closed end and at least one opening, such as a vial. In some embodiments, the marking element is at the outer surface. In some embodiments, the body has two open ends, such as for a syringe.

In some embodiments, the body has at least one wall, which may be enclosed at least partially between the inner surface and the outer surface, the location of the marking element extending at least in part across at least one volume area within the wall.

In some embodiments, the body comprises as body parts:
i) a glass tube with a first end and a further end, the glass tube defining a longitudinal axis L_{tube} and comprises, in a direction from the top to the bottom:
ia) a top region that is located at the first end of the glass tube, the outer diameter of the top region being dt;
ib) a junction region that follows the top region;
ic) a neck region that follows the junction region, the outer diameter of the neck region being dn with dn < dt;
id) a shoulder region that follows the neck region; and
ie) a body region that follows the shoulder region and that extends to the further end of the glass tube, the thickness of the glass in the body region being lb and the outer diameter of the body region is db with db > dt; and
ii) a glass bottom that closes the glass tube at the further end.

If the marking element extends across a volume area within the wall, it is possible to further protect the marking element from damages, such as mechanical damages, occurring due to handling or other influences, hence, providing an even more durable marking element.

In some embodiments, the extension of the marking element, such as when projected on at least one 2D plane, in at least one dimension, such as in two or three dimensions, is small compared to the maximal extension of the container in the respective one or more directions and/or compared to the maximal overall extension of the container. The extension of the marking element is small if it is not more than 0.8 or 2 mm, or if it is less than 90 %, 80 %, 70 %, 60 %, 50 %, 40 %, 30 %, 20 %, 10 %, 5 %, 3 %, 1 %, 0.1 %, 0.01 % and/or 0.001 % of the respective comparative size.

Small dimensions of the marking element allow providing a marking element for a body also in case that only limited space is available. The 2D plane is, for example, a plane parallel to the surface of the body. Projecting the marking element on a 2D plane allows eliminating possible extensions in a third dimension such as a depth extension of the marking element. In other words, projecting the marking element on a 2D plane may allow assessing the two dimensions of the marking element which are not extending along the wall thickness of the body in which it is provided.

In some embodiments, the combination of the following features is provided: the extension of the marking element, such as when projected on at least one 2D plane, in at least one dimension, such as in two or three dimensions, is small compared to the maximal extension of the container in the respective one or more directions, the extension of the marking element being small if it is not more than 0.8 or 2 mm; the extension of the marking element, such as when projected on at least one 2D plane, in at least one dimension, such as in two or three dimensions, is small compared to the maximal extension of the container in the respective one or more directions, the extension of the marking element being small if it is less than 10 %, 5 %, 3 %, 1 %, 0.1 %, 0.01 % and/or 0.001 % of the respective comparative size; the extension of the marking element, such as when projected on at least one 2D plane, in at least one dimension, such as in two or three dimensions, is small compared to the maximal overall extension of the container, the extension of the marking element being small if it is not more than 0.8 or 2 mm; and/or the extension of the marking element, such as when projected on at least one 2D plane, in at least one dimension, such as in two or three dimensions, is small compared to the maximal overall extension of the container, the extension of the marking element being small if it is less than 10 %, 5 %, 3 %, 1 %, 0.1 %, 0.01 % and/or 0.001 % of the respective comparative size.

In some embodiments, the maximal extension of the marking element is less than or equal to 2 mm.

In some embodiments, the marking element is graved into at least one surface of the body, such as the inner and/or outer surface, the marking element being located at the bottom of the body, such as at the center thereof, and/or wherein the marking element, such as when projected on at least one 2D plane, comprises at least one one-dimensional data code, at least one two-dimensional data code and/or at least one three-dimensional data code, such that the data code allows for identification of the container.

A graved marking element is particularly durable and easy to manufacture, for example by at least one laser and/or laser ablating technique. An exemplary type of laser is a Diode Pumped Solid State (DPSS) Laser, a fiber laser or a Flash Lamp Pumped Solid State laser. Indeed, UV lasers might also be used, such as having a wavelength of 250 to 500 nm. They are suitable for ablating techniques since they are fast and reliable and allow fabricating small structures. However, also lasers having a wavelength between 250 and 600 nm might be employed. In some embodiments, a CO₂ laser might be employed.

If the marking element is located at the bottom, such as near the center of the bottom, such as at the center of the bottom, of the body it can be read comfortably from beneath the container where it is always in the field of view.

Choosing a respective one or multi-dimensional data code allows complying with requirements with respect to data density, data processing, redundancy or the like because different types of codes allow encoding different amounts of data. Furthermore, different types of codes might affect the container differently since they represent different degrees of damages of the body.

The 2D plane is, for example, a plane parallel to the surface of the body. Projecting the marking element on a 2D plane allows eliminating possible extensions in a third dimension such as a depth extension of the marking element, hence, providing a more clear assessment of the dimension of the marking element.

In some embodiments, the combination of the following features is provided: the marking element is graved into at least one surface of the body, such as the inner surface, the marking element being located at the bottom of the body, such as at the center thereof; the marking element, such as when projected on at least one 2D plane, comprises at least one one-dimensional data code, such that the data code allows for identification of the container; the marking element is graved into at least one surface of the body, such as the inner surface, the marking element being located at the bottom of the body, such as at the center thereof; the marking element, such as when projected on at least one 2D plane, comprises at least one two-dimensional data code, such that the data code allows for identification of the container; the marking element is graved into at least one surface of the body, such as the inner surface, the marking element being located at the bottom of the body, such as at the center thereof; the marking element, such as when projected on at least one 2D plane, comprises at least one three-dimensional data code, such that the data code allows for identification of the container; the marking element is graved into at least one surface of the body, such as the outer surface, the marking element being located at the bottom of the body, such as at the center thereof, the marking element, such as when projected on at least one 2D plane, comprises at least one one-dimensional data code, such that the data code allows for identification of the container; the marking element is graved into at least one surface of the body, such as the outer surface, the marking element being located at the bottom of the body, such as at the center thereof, the marking element, such as when projected on at least one 2D plane, comprises at least one two-dimensional data code, such that the data code allows for identification of the container; and/or the marking element is graved into at least one surface of the body, such as the outer surface, the marking element being located at the bottom of the body, such as at the center thereof, the marking element, such as when projected on at least one 2D plane, comprises at least one three-dimensional data code, such that the data code allows for identification of the container.

In some embodiments, the marking element is graved into at least one outer surface of the body.

In some embodiments, the data code, such as when projected on at least one 2D plane, comprises a plurality of dot-like elements and/or line-like elements, such as in form of at least one matrix code, such as at least one dot matrix code. Dots and lines are easy to produce and reliable for reading purposes.

The 2D plane is, for example, a plane parallel to the surface of the body. Projecting the marking element on a 2D plane allows eliminating possible extensions in a third dimension such as a depth extension of the marking element, hence providing a more clear assessment of the elements comprised by the data code.

In some embodiments, the data code comprises a plurality of dot-like elements and line-like elements in form of a matrix code.

In some embodiments, (i) the marking element is produced and/or can be produced by at least one laser ablation technique, at least one etching technique, such as at least one dry etching technique, at least one lithographic technique, at least one sandblasting technique and/or at least one surface modification technique without ablation of material by at least one laser followed by at least one treatment with a plasma; and/or (ii) the marking element can be read out by at least one camera and/or light, such as light emitted by at least one laser and/or at least one light emitting diode, such as the light having a wave length in the visible, infrared and/or ultra violet light spectrum.

A laser, such as a CO₂ laser, a Diode Pumped Solid State (DPSS) Laser, a fiber laser or a Flash Lamp Pumped Solid State laser, is commercially available, hence, this provides a straight-forward way of implementation. Indeed, UV lasers might also be used, such as having a wavelength of 250 to 500 nm. They are suitable for ablating techniques since they are fast and reliable and allow fabricating small structures. However, also lasers having a wavelength between 250 and 600 nm might be employed. Furthermore, dry etching techniques are also possible because they can be particularly used in the field of pharmaceutical containers since no contaminants are produced during application.

A machine-readable marking element allows for an automation of the processes the container is involved in. For example, with a readable marking element by a camera and/or a light source, a commercially available solution with a straightforward implementation of the reading procedure is possible.

In some embodiments, the combination of the following features is provided: the marking element: is produced by at least one laser ablation technique, at least one etching technique, such as at least one dry etching technique, at least one lithographic technique, at least one sandblasting technique, at least one surface modification technique without ablation of material by at least one laser followed by at least one treatment with a plasma; can be produced by at least one laser ablation technique, at least one etching technique, such as at least one dry etching technique, at least one lithographic technique, at least one sandblasting technique and/or at least one surface modification technique without ablation of material by at least one laser followed by at least one treatment with a plasma.

In some embodiments, the combination of the following features is provided: the marking element can be read out by at least one camera; the marking element can be read out by light, such as light emitted by at least one laser, such as the light having a wave length in the visible light spectrum; the marking element can be read out by at least one camera; the marking element can be read out by light, such as light emitted by at least one laser, such as the light having a wave length in the infrared light spectrum; the marking element can be read out by at least one camera; the marking element can be read out by light, such as light emitted by at least one laser, such as the light having a wave length in the ultra violet light spectrum; the marking element can be read out by light, such as light emitted by at least one light emitting diode, such as the light having a wave length in the visible light spectrum; the marking element can be read out by light, such as light emitted by at least one light emitting diode, such as the light having a wave length in the infrared light spectrum; and/or the marking element can be read out by light, such as light emitted by at least one light emitting diode, such as the light having a wave length in the ultra violet light spectrum.

In some embodiments, the marking element is produced or can be produced by at least one laser ablation technique.

In some embodiments, the container, such as the body, (i) comprises or consists of glass, such as silicate glass such as alumosilicate glass and/or borosilicate glass, and/or at least one polymer material; and/or (ii) is designed at least partly in form of a syringe, in the form of a cartridge, in the form of a vial and/or in the form of another pharmaceutical container, such that the bottom of the body has at least partially a concave shape, the center of the osculating circle at at least one point of the bottom of the body lies on the side opposite to the body with respect to the body’s bottom.

If the container (such as the body thereof) is designed such that it has a concave bottom, a code graved into the bottom, such as into the outer surface of the bottom, it can be better protected from mechanical damages.

In some embodiments, the combination of the following features is provided: the container, such as the body: comprises or consists of glass, such as silicate glass such as alumosilicate glass; comprises borosilicate glass; comprises at least one polymer material; is designed at least partly in form of a syringe tube; is designed at least partly in the form of a cartridge; is designed at least partly in the form of a vial; is designed at least partly in the form of another pharmaceutical container; is designed at least partly in the form of a cartridge, the bottom of the body having at least partially a concave shape, such as the center of the osculating circle at at least one point of the bottom of the body lies on the side opposite to the container with respect to the body’s bottom; is designed at least partly in the form of a vial, the bottom of the body having at least partially a concave shape, such as the center of the osculating circle at at least one point of the bottom of the body lies on the side opposite to the container with respect to the body’s bottom; and/or is designed at least partly in the form of another pharmaceutical container, the bottom of the body having at least partially a concave shape, such as the center of the osculating circle at at least one point of the bottom of the body lies on the side opposite to the container with respect to the body’s bottom.

In some embodiments, the container comprises or consists of glass and is designed in the form of a vial.

In some embodiments, the body is treated at least partially, such as at the location of the marking element, with a tempering procedure, such as at a temperature of between 300° C. and 400° C. and/or for a duration of between 10 and 25 minutes.

By respective tempering, it can be prevented that cracks, such as cracks on a microscale, present in the body grow or extend further. Furthermore, it has been observed that respective tempering leads to a cleaning of the container, such as the body, which is particularly useful in the field of pharmaceutical containers. Tempering can have a sterilizing effect so that the container, such as the body, becomes sterile. This is also particularly useful in the field of pharmaceutical containers.

In some embodiments, the combination of the following features is provided: the body is treated at least partially, such as at the location of the marking element, with a tempering procedure; the body is treated at least partially, such as at the location of the marking element, with a tempering procedure, at a temperature of between 300° C. and 400° C. and for a duration of between 10 and 25 minutes; the body is treated at least partially, such as at the location of the marking element, with a tempering procedure, at a temperature of between 300° C. and 400° C.; the body is treated at least partially, such as at the location of the marking element, with a tempering procedure for a duration of between 10 and 25 minutes.

Exemplary embodiments provided according to the present invention provide a method for producing a container for holding at least one pharmaceutical composition, comprising:
providing at least one body, such as a body which is at least in part hollow, has at least one closed end, has two open ends and/or has at least one opening;
identifying at least one location at the body, with the body at this location having at least one stress parameter which has, such as under at least one state condition, a value less than or equal to at least one threshold value;
the threshold value being derived and/or derivable from at least one simulation result of at least one simulation based on a finite element method of the stress parameter for at least one surface and/or volume area of the body with or without the marking element present; at least one mean value is or can be obtained by the simulation for the stress parameter for at least a part of the surface and/or volume area of the body; the threshold value being the sum of the mean value and 1000 % or less of the absolute value of the mean value;
providing at least one marking element, which allows identification of the container, at the identified location.

Exemplary embodiments provided according to the present invention are thus based on the surprising finding that, during the manufacturing process of a container, a marking element can be provided on the container, such as on the body, by techniques which lead to a weakening of the material, for example due to material ablation, if the location of the marking element is chosen such that for the location of the marking element, one or more stress parameters are restricted to a certain threshold value. Locations fulfilling this criterion can be used for permanently graving the marking element into the container while still ensuring a high strength of the container irrespective of the damages the marking element represents in the structure of the body.

With respect to the further advantages arising from choosing the location dependent on the stress parameter reference is made to the previous discussion.

In some embodiments, identifying the location at the body comprises:
evaluating the simulation results of the body and identifying at least one area where the stress parameter has a value, such as an averaged value of that stress parameter over that area, less than the threshold value; and
choosing the location such that it is at least partly within the identified area.

The area which is identified as being a location for the marking element can be chosen such that at least one value of the stress parameter obtained by the simulation for that area fulfills the threshold criterion. Hence, the area in every point fulfills the threshold criterion.

Alternatively, the location can be chosen such that an averaged value of that stress parameter obtained by the simulation for that area fulfills the threshold criterion. This allows that the identified area might have single points which do not fulfill the criterion, however, in average the area does so. This allows a practical and a more robust approach.

In some embodiments, providing the marking element comprises: ablating and/or etching at the identified location material from at least one surface area of the body, such as by at least one first laser, at least one etching technique, such as at least one dry etching technique, at least one lithographic technique, at least one sandblasting technique, at least one surface modification technique without ablation of material by at least one laser followed by at least one treatment with a plasma, and/or manipulating at the identified location at least one volume area of the body, such as by the first laser, hence, creating a marking element, such as a data code, which can be read out by at least one camera and/or light, such as light emitted by at least one second laser and/or at least one light emitting diode, such as the light having a wave length in the visible, infrared and/or ultra violet light spectrum, the first laser may be (i) is a Diode Pumped Solid State (DPSS) Laser, a fiber laser, a UV laser, a CO₂ laser or a Flash Lamp Pumped Solid State laser, (ii) is a pulsed laser, such as (a) having a pulse duration between 100 ps and 500 ns, such as 100 ns, (b) having a pulse energy between 1 and 500 µJ, (c) having a pulse repetition rate between 10 and 400 kHz, and/or (d) having a RMS power of between 1 and 100 watts, such as 5 watts, and/or (iii) has a wavelength between 250 and 600 nm, such as 368 nm.

Using a laser, such as a CO₂ laser, a Diode Pumped Solid State (DPSS) Laser, a fiber laser or a Flash Lamp Pumped Solid State laser, is an exemplary technique in the pharmaceutical field because it allows producing very small structures. Indeed, UV lasers might also be used, such as having a wavelength of 250 to 500 nm. They are suitable for ablating techniques since they are fast and reliable and allow fabricating small structures. However, also lasers having a wavelength between 250 and 600 nm might be employed.

Using a dry etching technique is also an exemplary technique in the pharmaceutical field because no contaminations occur. Dry etching and laser are both plasma/solid interactions.

In some embodiments, providing the marking element comprises the step of: ablating and/or etching at the identified location material from at least one surface area of the body, such as by at least one first laser, at least one etching technique, such as at least one dry etching technique, at least one lithographic technique, at least one sandblasting technique, at least one surface modification technique without ablation of material by at least one laser followed by at least one treatment with a plasma, and/or manipulating at the identified location at least one volume area of the body, such as by the first laser, hence, creating a marking element, such as a data code, which can be read out by at least one camera and/or light, such as light emitted by at least one second laser and/or at least one light emitting diode, such as the light having a wave length in the visible, infrared and/or ultra violet light spectrum, wherein the first laser (i) is a Diode Pumped Solid State (DPSS) Laser, a fiber laser, a UV laser, a CO2 laser or a Flash Lamp Pumped Solid State laser, (ii) is a pulsed laser, such as (a) having a pulse duration between 100 ps and 500 ns, such as 100 ns, (b) having a pulse energy between 1 and 500 µJ, (c) having a pulse repetition rate between 10 and 400 kHz, and/or (d) having a RMS power of between 1 and 100 watts, such as 5 watts, and/or (iii) has a wavelength between 250 and 6500 nm, such as 368 nm.

By respective tempering it can be prevented that cracks present in the body, particularly cracks on a microscale, further extend. Furthermore, it has been observed that respective tempering lead to a cleaning of the container, such as the body, which is particular useful in the field of pharmaceutical containers.

In some embodiments, providing the marking element comprises: ablating at the identified location material from at least one surface area of the body.

In some embodiments, a UV laser is used.

In some embodiments, the method further comprises: treating the body at least in part, such as at the location of the marking element, with a tempering procedure, such as at a temperature of between 300° C. and 400° C. and/or for a duration of between 10 and 25 minutes.

The person skilled in the art clearly understands that all structural features disclosed with respect to any one of the previously described embodiments provided according to the present invention might also be subject to features of the method.

Further relevant aspects of embodiments provided according to the present invention are discussed further herein.

As mentioned previously, for glass containers, such as glass vials, used in the pharmaceutical industry, axial compression and side compression have been identified as common and typical load situations during handling, processing and transportation. Both types of compression might lead to compression stresses and/or tensile stresses. These stresses can occur in the outer and/or inner surface of the container, such as the body thereof.

In some embodiments, the container, such as the body, is a vial.

In some embodiments, the vial might be a vial of size 2R, 4R, 6R, 8R 10R, 15R, 20R, 25R, 30R, 50R, 100R.

In some embodiments, the two types of loads might occur in different surface and/or volume regions of the container, such as the body. For example, the side compression occurs in the area of the neck and and/or the axial compression occurs in the area of the bottom.

It is particularly noted that the axial and side compression strength can be verified by appropriate strength experiments: axial compression strength, for example, of vials can be tested according to DIN EN ISO 8113:2004 by application of an axial compression load with a constant load rate until failure of the specimen. Side compression strength of vials can be tested by application of a radial (diametral/side) compression load with a constant load rate until failure of the specimen.

The following situations have been identified with respect to axial compression: for example, during packaging of the containers, they experience pressure from above, hence axial compression. This is the case because, for example, the containers are stacked onto each other. Also, during freeze-drying (lyophilization), typically axial compression occurs. This is the case because, in one application of freeze-drying, a holder is attached to the container, such as a vial, such as a glass vial, for holding it. This causes mechanical stresses in the form of axial compression to the container. In another application of freeze-drying, alternatively or in addition, the container is put on a cooling plate and pressed from above. This causes mechanical stresses in form of axial compression to the container as well. Also when the container is closed, such as using a crimp closure, axial compression occurs.

Of course, under both axial compression and side compression, tensile stresses can occur. And under both axial compression and side compression, compression stresses can occur.

It is acknowledged that under axial load, axial compression takes place. It is acknowledged that under side load, side compression takes place.

The following situations have been identified with respect to side compression: for example, during handling of the container, side compression occurs in the container.

As a tendency, it can be said that locations where tensile stresses are low may be advantageous for providing a marking element and/or that locations where the absolute value of the compression stresses are high may be advantageous for providing a marking element. It is noted that tensile stresses are characterized by a positive value while compressive stresses are characterized by a negative value. Thus, high absolute values of compressive stresses mean that there is a high compressive stress.

It has been particularly found that, in some embodiments, locations with tensile stresses of up to 150 MPa might still be considered as being a location for the marking element.

In the context of the present invention, every pharmaceutical composition which the skilled person deems suitable comes into consideration. A pharmaceutical composition is a composition comprising at least one active ingredient. An exemplary active ingredient is a vaccine, an antibody or other biological agent. The pharmaceutical composition may be fluid or solid or both. An exemplary solid composition is granular such as a powder, a multitude of tablets or a multitude of capsules. A further exemplary pharmaceutical composition is a parenteral, i.e. a composition which is intended to be administered via the parenteral route. Parenteral administration can be performed by injection, e.g. using a needle (usually a hypodermic needle) and a syringe, or by the insertion of an indwelling catheter.

Further relevant aspects concerning the container are now discussed. For the sake of this discussion it is assumed that the container, such as the body thereof, made of glass. It is furthermore assumed that the container is designed such as in form of a vial. But, of course, every other type of container might be possible as well.

The above described pharmaceutical glass containers should be characterized by sufficiently high strength, particularly if they are filled in automated capping machines in which substantial axial loads are applied to the vials. Higher axial loads may also be observed when glass vials are used in automated sampling machines in scientific labs or medical institutions as well as during stoppering, shipping, and storage of glass vials. In addition to a certain resistance to axial loads glass containers should also display sufficiently high burst strength. Burst pressure testing is, for example, appropriate for assessing container strength during lyophilisation to find the weakest point on the interior or exterior surface of a container. Burst strength of pharmaceutical glass containers becomes important if pharmaceutical preparations, after they have been filled in a glass container, are subjected to lyophilisation.

As the use of glass containers in pharmaceutical industry only allows a very low failure probability upon application of mechanical stress or pressure changes, glass containers intended for the filling of pharmaceutical preparations should therefore be characterized by sufficiently high strength, particularly by the ability to withstand high axial loads and by sufficiently high burst strength.

In addition, it should have the ability to withstand a certain pressure in the below described side compression test.

In the pharmaceutical industry, containers are used for the primary packaging of drugs. Among the traditionally most used materials is a glass container, as it ensures stability, visibility, endurance, rigidity, moisture resistance, ease of capping, and economy. The glass containers for medicinal purposes currently on the market include glass containers, made from glass tubing and blow-molded glass containers.

Glass vials that are intended for pharmaceutical packaging must pass numerous mechanical tests. High axial loads that are determined in a so called “vertical compression test” (or also called “axial compression test”) may, for example, be required if glass vials are used in automated sampling machines in scientific labs or medical institutions as well as during stoppering, shipping, and storage of glass vials. In addition to a certain resistance to axial loads, glass containers should also display sufficiently high burst strength as determined in the so-called “burst pressure test”. Burst pressure testing is, for example, appropriate if pharmaceutical preparations, after they have been filled in a glass container, are subjected to lyophilisation in order to find the weakest point on the interior or exterior surface of a container.

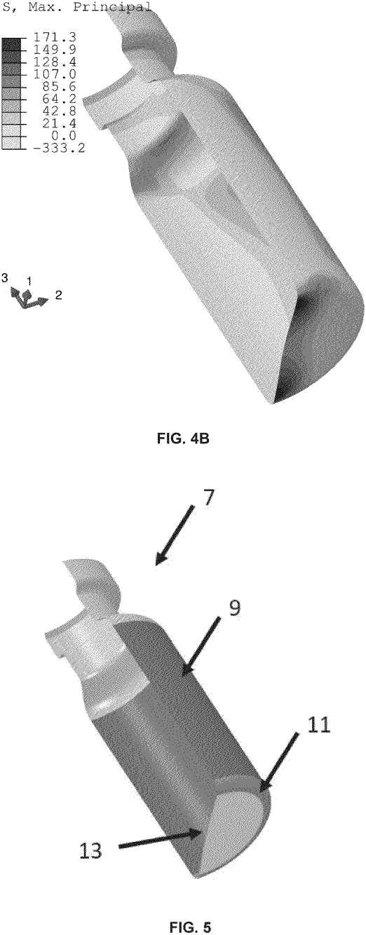

A further mechanical test that is often used to determine the mechanical strength of a glass vial is the so called “side compression test”. This test is used, for example, to determine the impact that a certain back pressure may have on the glass vials during transport in a depyrogenation tunnel or generally during transport on a filling line. In this test, the glass vials are positioned between an upper and a lower portion of a test tool as shown in FIG. 4A (and described in more detail further herein), wherein a defined load is applied directly onto the body region of the glass vial.

The glass container provided according to the present invention or the glass container contained in the plurality of glass containers provided according to the present invention may have any size or shape which the skilled person deems appropriate in the context of the present invention. The top region of the glass container may comprise an opening, which allows for inserting a pharmaceutical composition into the interior volume of the glass container. The glass container comprises as container parts a glass tube with a first end and a further end and a glass bottom that closes the glass tube at the further end. The glass container may be of a one-piece design that is prepared by providing a glass tube and by closing one end thereof (i.e. the end that will be the opening of the glass container) so as to obtain a top region, a junction region, a neck region and a shoulder region followed by shaping the further end of the glass tube so as to obtain a closed glass bottom. An exemplary glass container is a pharmaceutical glass container, such as one selected from the group consisting of a vial, an ampoule or a combination thereof.

The glass of the container may be any type of glass and may consist of any material or combination of materials which the skilled person deems suitable in the context of the invention. The glass may be suitable for pharmaceutical packaging. In some embodiments, the glass is of type I, such as type I b, in accordance with the definitions of glass types in section 3.2.1 of the European Pharmacopoeia, 7th edition from 2011. Additionally or alternatively, the glass is selected from the group consisting of a borosilicate glass, an aluminosilicate glass, soda lime glass and fused silica; or a combination of at least two thereof. For use herein, an aluminosilicate glass is a glass which has a content of Al₂O₃ of more than 8 wt.-%, such as more than 9 wt.-%, such as in a range from 9 to 20 wt.-%, in each case based on the total weight of the glass. An exemplary aluminosilicate glass has a content of B₂O₃ of less than 8 wt.-%, such as at maximum 7 wt.-%, particularly such as in a range from 0 to 7 wt.-%, in each case based on the total weight of the glass. For use herein, a borosilicate glass is a glass which has a content of B₂O₃ of at least 1 wt.-%, such as at least 2 wt.-%, at least 3 wt.-%, at least 4 wt.-%, at least 5 wt.-%, or in a range from 5 to 15 wt.-%, in each case based on the total weight of the glass. An exemplary borosilicate glass has a content of Al₂O₃ of less than 7.5 wt.-%, such as less than 6.5 wt.-% or in a range from 0 to 5.5 wt.-%, in each case based on the total weight of the glass. In a further aspect, the borosilicate glass has a content of Al₂O₃ in a range from 3 to 7.5 wt.-%, such as in a range from 4 to 6 wt.-%, in each case based on the total weight of the glass.

A glass which is further exemplary according to the present invention is essentially free of boron (B). Therein, the wording “essentially free of B” refers to glasses which are free of B which has been added to the glass composition by purpose. This means that B may still be present as an impurity, but at a proportion of not more than 0.1 wt.-%, such as not more than 0.05 wt.-%, in each case based on the weight of the glass.

### Axial Load and Burst Pressure

The mechanical resistance against axial compression of the vial can be determined by vertical load strength testing in accordance to DIN EN ISO 8113:2004 (“Glass containers -Resistance to vertical load - Test methods”), where a compressive force is applied in axial direction and is increased with a constant load rate of 500 N/min until breakage of the container.

The mechanical resistance against internal pressure of the vial is determined by means of burst strength testing in accordance to DIN EN ISO 7458:2004 (“Glass containers -Internal pressure resistance - Test methods”), where a hydraulic pressure is applied from inside of the vial and is increased with a constant load rate of 5.8 bar/s until breakage of the container.

### Side Compression Test

The mechanical resistance of the vial body section against diametral compression can be determined by a diametral load strength testing adapted from DIN EN ISO 8113:2004 (“Glass containers - Resistance to vertical load - Test methods”), where a compressive force is applied in diametral (radial) direction at two opposing positions of the vial body outer surface geometry. The compressive force is increased at a constant load rate of 1500 N/min until breakage of the container using a universal testing machine (breakage can again be detected as a sudden drop in the force- time diagram F(t)). The diametral load is applied by two opposing, uniaxial concave steel surfaces, between which the body section of the vial is placed parallel to the axis. One of the concave surfaces is constructed to be self-adjusting to be able to compensate geometrical irregularities. The radius of the concavity of the two steel surfaces is 25% larger than the radius of the outer diameter of the body section, so that the load is applied along two opposing lines. The width of the concave steel surfaces is chosen to be larger than the height of the vial body section.

### Neck Squeeze Test

The mechanical resistance of the vial neck section against diametral compression can be determined by a diametral load strength testing adapted from DIN EN ISO 8113:2004 (“Glass containers - Resistance to vertical load - Test methods”), where a compressive force is applied in diametral (radial) direction at two opposing positions of the vial neck outer surface geometry. The compressive force is increased at a constant load rate of 2000 N/min until breakage of the container using a universal testing machine (breakage can be detected as a sudden drop in the force-time diagram F(t)). The diametral load is applied by two opposing, uniaxial concave steel surfaces, between which the neck section of the vial is placed parallel to the axis. One of the concave surfaces is constructed to be self-adjusting to be able to compensate geometrical irregularities. The radius of the concavity of the two steel surfaces is 25% larger than the radius of the outer diameter of the neck section, so that the load is applied along two opposing lines. The width of the concave steel surfaces is chosen to be slightly shorter than the height of the vial neck section.

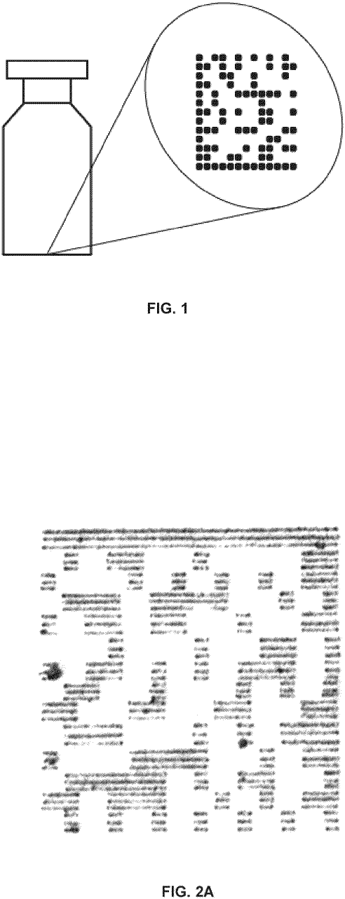

FIG. 1 shows an illustration of a container in form of a vial with a marking element indicated on the bottom of the vial.

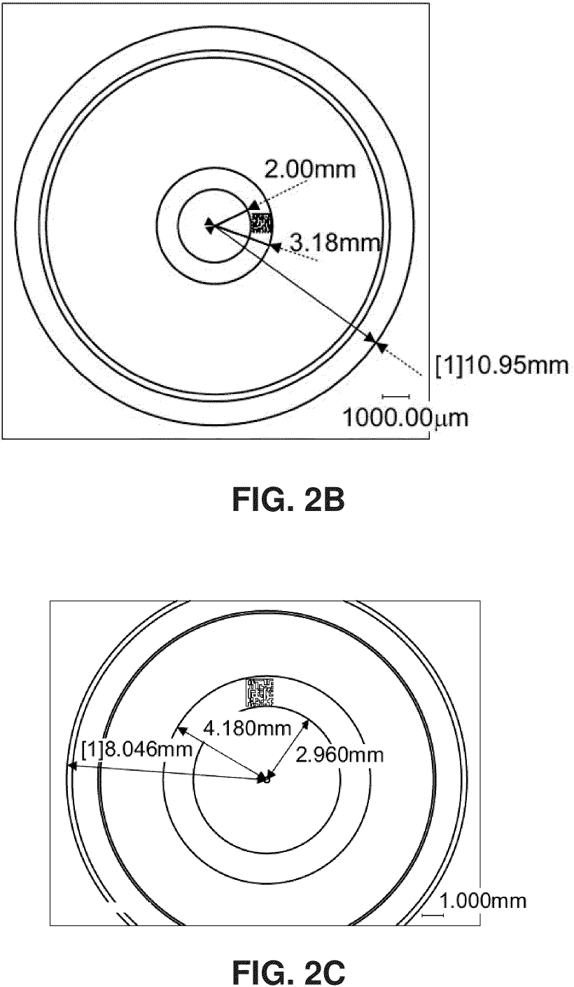

FIG. 2A shows a marking element in a close up view. The marking element here is graved into a glass substrate for demonstration purposes.

FIG. 2B shows another marking element graved into the bottom outer surface of a glass vial. From the captions shown in the figure, dimensions of the marking element can be deduced. In a first direction, the extension of the marking element is 1.18 mm. Since the marking element is square in shape, it has also in a second direction an extension of 1.18 mm.

FIG. 2C shows another marking element graved into the bottom outer surface of a glass vial. From the captions shown in the figure, dimensions of the marking element can be deduced. In a first direction, the extension of the marking element is 1.22 mm. Since the marking element is square in shape, it has also in a second direction an extension of 1.22 mm.

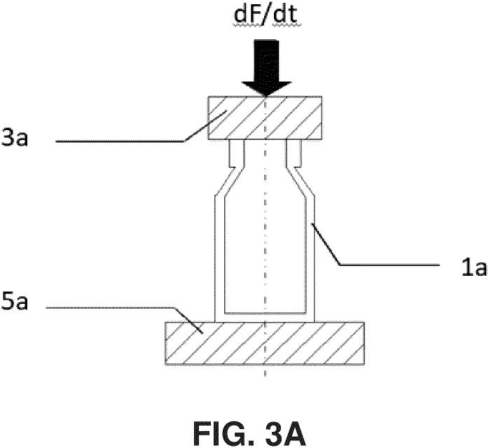

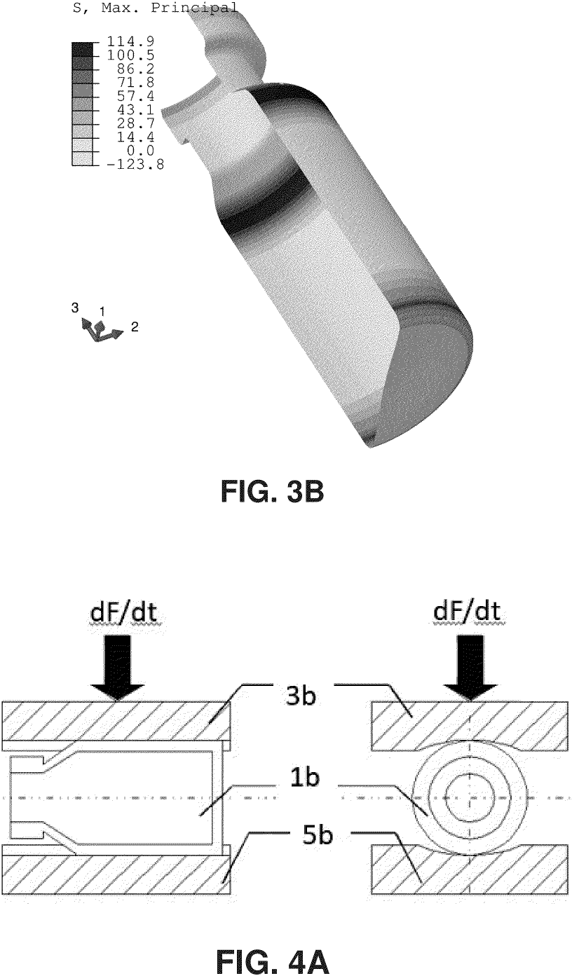

FIG. 3A shows an illustration of a setup for an axial compression test. This setup allows verifying the axial compression strength. Axial compression strength, for example of a glass vial 1a, can be tested according to DIN EN ISO 8113:2004 by application of an axial compression load F with a constant load rate until failure of the specimen (vial 1a). The vial 1a here is sandwiched between a self-adjusting steel plate 3a and a rigid steel plate 5a.

FIG. 3B shows an exemplary contour plot of the stress distribution on the outer surface of a 2 mL tubular glass vial under axial compression as it might be obtained by means of the axial compression test described with respect to FIG. 3A.

FIG. 4A shows an illustration of a setup for a side compression test. This setup allows verifying the side compression strength. Side compression strength, for example of a glass vial 1b, can be tested adapted from DIN EN ISO 8113:2004 (see for further details the respective section dealing with the side compression test previously) by application of a side compression load F with a constant load rate until failure of the specimen (vial 1b). The vial 1b here is sandwiched between a self-adjusting steel plate 3b and a rigid steel plate 5b.

FIG. 4B shows an exemplary contour plot of the stress distribution on the outer surface of a 2 mL tubular glass vial under side compression as it might be obtained by the side compression test described with respect to FIG. 4A.

From FIG. 3B and FIG. 4B, it can be deduced that both load situations induce comparatively low tensile stresses (or they induce even compression stresses) in the center of the vial base outer surface. This might be an indicator that this is a position for laser marking.

It is in this respect noted that the strength of glass can be regarded as a projection of its surface quality, hence varying with the surface conditions depending on handling, processing and transportation. However, typical (tensile) strength values for glass products range between approximately 30 and 70 MPa. Accordingly, a value of tensile stress of 70 MPa appears as a reasonable lower specification limit of strength for laser markings. Inducing tensile stresses of 70 MPa on the vial base outer surface requires different magnitudes of compression forces, depending on the vial geometry and the load situation.

It is obvious from the figures that under different loads there are different critical regions present. However, exemplary embodiments provided according to the present invention allow identifying the location based on the simulation results such that only low tensile stresses (or even compressive stresses) are present, hence a marking element can be provided at respective locations without the risk of less stability of the vial. This is particularly true because locations having tensile stresses must be avoided while locations having compressive stresses might be advantageous for providing a marking element.

In any event, based on the simulation results, it is possible to determine a mean value of a stress parameter, which in turn might serve as a relative value for setting the threshold value according to the present invention (indeed, the mean value serves as basis to calculate a sum which in turn is relevant for the threshold value). This aspect also shows that dependent on the loads which probably are applied to the container (such as a vial, such as a vial as shown in FIG. 3A and FIG. 4A) during use, the respective simulation data can be used for determining the threshold value. This constitutes a quite flexible approach.

In other words, if results such as the ones shown in FIGS. 3B and 4B are obtained from a simulation of a vial which should be subject to marking, it would be possible to define for the bottom of the vial a location based on a mean value derived from the distributions. For example, regions of the bottom of the vial having a tensile stress below a first threshold under a first state condition (being, for example, axial compression) and having a tensile stress below the first threshold under a second state condition (being, for example, side compression) might be identified locations. And/or, for example, regions of the bottom of the vial having a first principle stress less below a certain threshold under a certain state condition (being, for example, axial or side compression) might be identified locations.

FIG. 5 shows a perspective cut-view of a model of a vial 7. In some embodiments, the marking element must be provided on a pre-selected part of the container (such as in the form of the vial 7), for example due to certain specifications concerning accessibility of the marking element or the like. Such a part might be, for example, the cylindrical wall 9 of the vial, the heel 11 of the vial or the bottom 13 of the vial. It is then advantageous to limit the simulation to the respective part of the container so that only values from that part are taken into account for determining the mean value, hence, the threshold value.

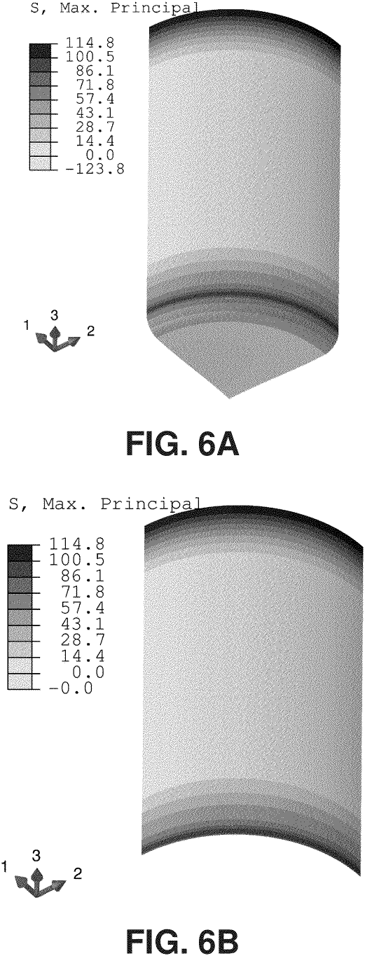

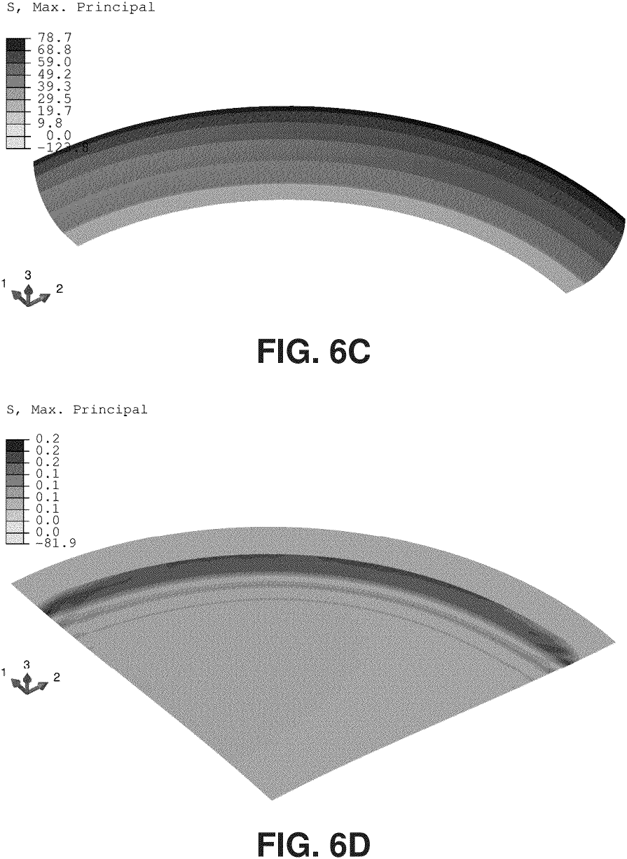

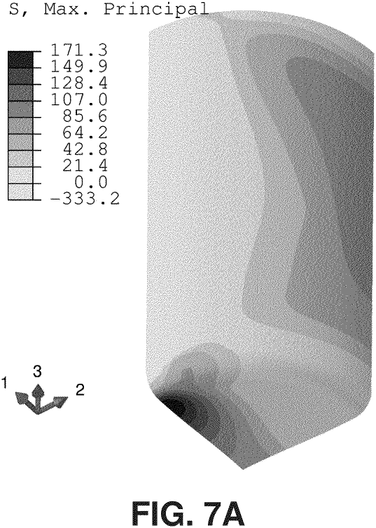

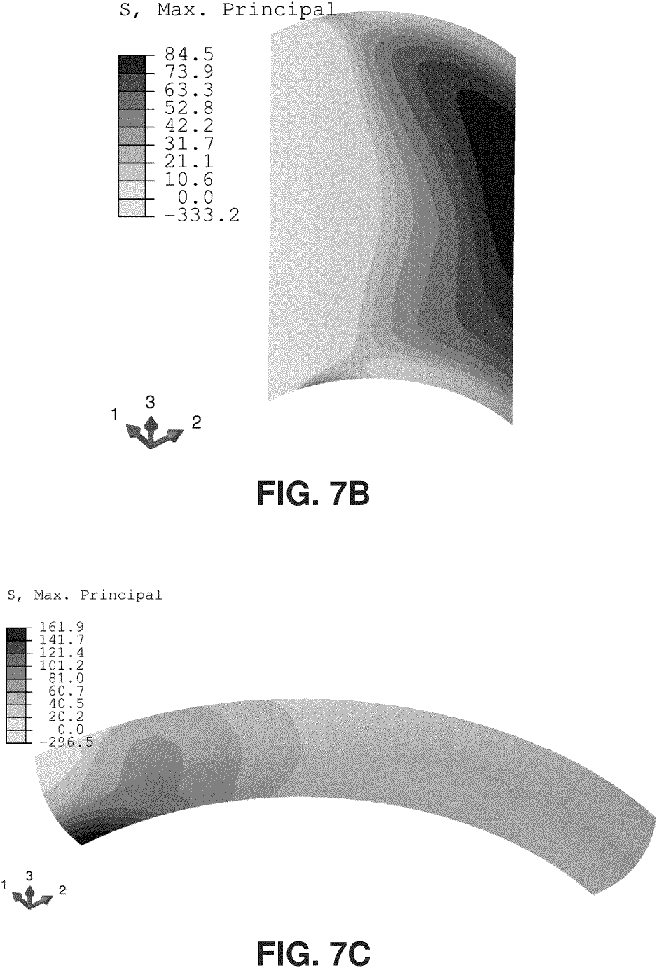

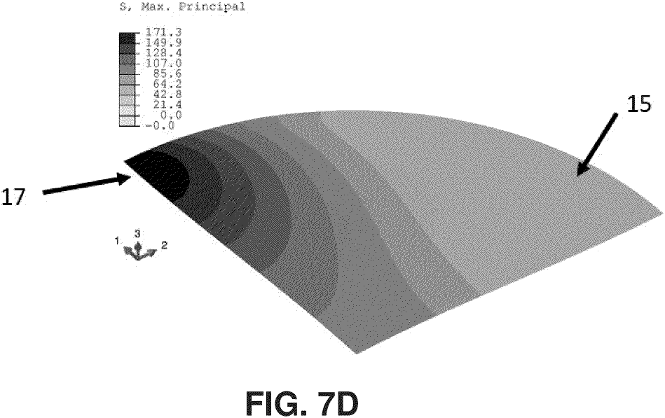

FIGS. 6A-6D and FIGS. 7A-7D show different contour plots of the distributions of the first principle stress under, respectively, axial compression and side compression as will be outlined in more detail further herein. The code of the key is chosen for FIGS. 6A-6D and FIGS. 7A-7D such that only tensile stresses are shown from light to dark. Compressive stresses (values less than zero) are represented light. It is always shown the first principle stress in the contour plots, which means that for each point the maximal stress is shown, independent from the direction of the stress. Each plot represents only one quarter of the complete element under consideration, which is sufficient since the elements are rotational symmetric.

For the axial compression:

FIG. 6A shows the contour plot of the entire vial 7 shown in FIG. 5. From the distribution, the average weighted value for the first principle stress can be calculated to 15.7 MPa.

FIG. 6B shows the contour plot of the cylindrical wall 9 of vial 7 only as shown in FIG. 5. From the distribution, the average weighted value for the first principle stress can be calculated to 17.6 MPa.

FIG. 6C shows the contour plot of the heel 11 of vial 7 only as shown in FIG. 5. From the distribution, the average weighted value for the first principle stress can be calculated to 22.2 MPa.

FIG. 6D shows the contour plot of the bottom 13 of vial 7 only as shown in FIG. 5. From the distribution, the average weighted value for the first principle stress can be calculated to -4.3 MPa.

For the side compression:

FIG. 7A shows the contour plot of the entire vial 7 shown in FIG. 5. From the distribution, the average weighted value for the first principle stress can be calculated to 28.0 MPa.

FIG. 7B shows the contour plot of the cylindrical wall 9 of vial 7 only as shown in FIG. 5. From the distribution, the average weighted value for the first principle stress can be calculated to 26.9 MPa.

FIG. 7C shows the contour plot of the heel 11 of vial 7 only as shown in FIG. 5. From the distribution, the average weighted value for the first principle stress can be calculated to 19.8 MPa.

FIG. 7D shows the contour plot of the bottom 13 of vial 7 only as shown in FIG. 5. From the distribution, the average weighted value for the first principle stress can be calculated to 43.4 MPa.

The evaluation of FIGS. 6A-6D and 7A-7D shows that dependent on the part of the vial 7 on which the marking element should be provided, different stress values, hence, different average weighted values, are obtained from the simulation results depicted in the contour plots of FIGS. 6A-6D and 7A-7D. All the more, the results, hence the average values, are also different for axial and side compression. This in turn means that dependent on the part of the vial 7 which is considered for providing the marking element, a different threshold value is obtained. Or in other words, for different parts of the vial 7, the region identified for providing a marking element can have different stress values, hence, different mean values, hence, different thresholds. Thus, while a threshold might be appropriate for determining a location at the bottom under side compression, it might be inappropriate for determining a location at another part under side compression.

Indeed, this makes it clear that the teachings of the present invention can be applied independently of the geometry, size and shape of the respective container since the threshold is defined relative to the mean value.

For example, assuming that a marking element must be necessarily provided on the bottom 13 of the vial 7 (since, for example, other parts of the vial are not accessible for writing and/or reading the marking element) as a pre-condition. Let now the relevant stress parameter be the first principle stress and let the state condition be 1700 N of side compression. Finally let the threshold value be the sum of the averaged weighted mean value and 100 % of the absolute value of the averaged weighted mean value (with the averaged, weighted mean value obtained from the simulation). Consequently, in order to determine a location on which the marking element can be provided, a simulation is run for the bottom 13 of the vial 7 with respect to the first principle stress with a side compression of 1700 N is applied.

The simulation then yields a contour plot as the one of FIG. 7D. From that, the average weighted value for the first principle stress of 43.4 MPa can be obtained (see above). Finally, the threshold value is defined as being 43.4 MPa + 100 % of 43.4 MPa, hence, 86.8 MPa. As can be taken from the contour plot of FIG. 7D, approximately the right half part of the bottom 13 (area 15 in FIG. 7D) which is light might be an appropriate location for the marking element. In contrast, the top left corner (area 17 in FIG. 7D) of the bottom 13 shown in FIG. 7D is dark and has a value of over 170 MPa, hence, the threshold criterion is not fulfilled and a marking element should not be provided at this location.

Of course, this is just an example for the purpose of demonstrating one exemplary embodiment provided according to the present invention.

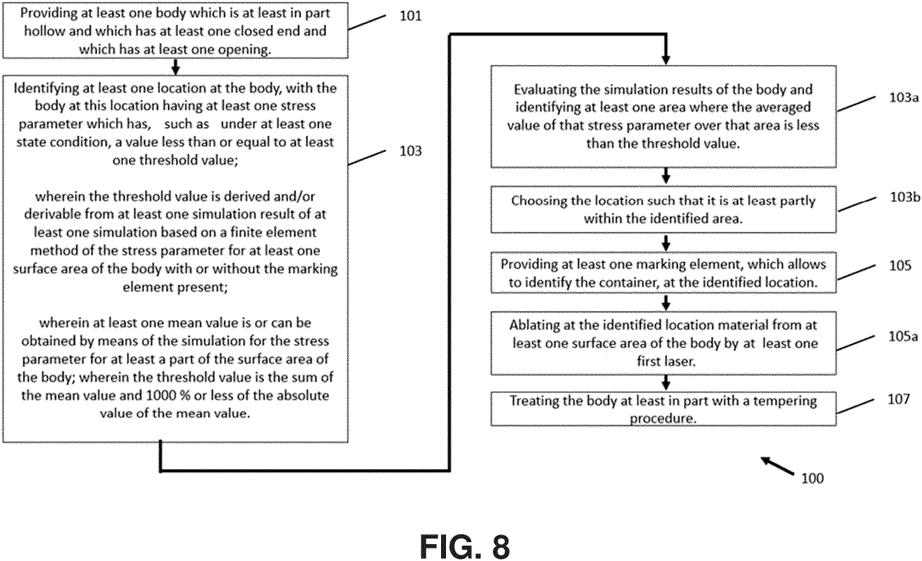

FIG. 8 shows a flow chart of an exemplary embodiment of a method 100 provided according to the present invention.

In a step 101, at least one body which is at least in part hollow and which has at least one closed end and which has at least one opening is provided. For example, this body can be the vial the model of which is shown in FIG. 5.

In a step 103, at least one location at the body, with the body at this location having at least one stress parameter which has, such as under at least one state condition, a value less than or equal to at least one threshold value is identified; wherein the threshold value is derived and/or derivable from at least one simulation result of at least one simulation based on a finite element method of the stress parameter for at least one surface area of the body with or without the marking element present; wherein at least one mean value is or can be obtained by the simulation for the stress parameter for at least a part of the surface area of the body; wherein the threshold value is the sum of the mean value and 1000 % or less of the absolute value of the mean value. For example, the stress parameter might be the first principle stress.

For example, the state condition might be 1700 N of side compression. For example, the first surface of the body might be the surface of the bottom of the body. For example, the threshold value might be 86.8 MPa, as it has been derived above with respect to FIG. 7D.

In a step 103a, which is comprised by the step 103, the simulation results of the body are evaluated and at least one area where the averaged value of that stress parameter over that area is less than the threshold value is identified.

For example, this might be the right half part 15 of the bottom of the vial’s body, see FIG. 7D.

In a step 103b, which is comprised by the step 103, the location is chosen such that it is at least partly within the identified area.

In a step 105, at least one marking element, which allows identification of the container at the identified location, is provided.

In a step 105a, which is comprised by the step 105, at the identified location material from at least one surface area of the body is ablated by at least one first laser. For example, this might be performed using an UV laser.

In a step 107, the body is treated at least in part with a tempering procedure.

Of course, even if the exemplary embodiments discussed above with respect to the FIGS. are referring to a certain product such as a vial or syringe, the person skilled in the art should understand that the discussed aspects apply accordingly to containers of other shape, geometry and size as well.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

Reference List

| | |
|---|---|
| 1a, 1b | Vial |
| 3a, 3b | Steel plate |
| 5a, 5b | Steel plate |
| 7 | Vial |
| 9 | Wall |
| 11 | Heel |
| 13 | Bottom |
| 15 | Area |
| 17 | Area |
| 100 | Flow chart |
| 101-107 | Step |
| F | Load (Force) |

What is claimed is:

1. A method for producing a container for holding at least one pharmaceutical composition, the method comprising:
providing a body;
identifying a location at the body, with the body at this location having at least one stress parameter which has a value less than or equal to a threshold value, the identifying comprising deriving the threshold value from a simulation result of a simulation based on a finite element method of the at least one stress parameter for at least one of a surface area or a volume area of the body with or without a marking element present, the identifying further comprising obtaining a mean value by the simulation for the at least one stress parameter for at least a part of at least one of the surface area or the volume area of the body, wherein the threshold value is a sum of the mean value and 1000 % or less of an absolute value of the mean value; and
providing a marking element which allows identification of the container at the identified location.

2. The method of claim 1, wherein the at least one stress parameter is at least one of a first principle stress, a mechanically induced tensile stress, a mechanically induced compressive stress, a thermally generated stress, or a chemically generated stress.

3. The method of claim 2, wherein the at least one stress parameter is a mechanically induced tensile stress and the threshold value is 100 MPa.

4. The method of claim 2, wherein the at least one stress parameter is a mechanically induced compressive stress and the threshold value is 50 MPa.

5. The method of claim 1, wherein at said location the at least one stress parameter of the body has a value less than or equal to the threshold value under at least one state condition.

6. The method of claim 5, wherein the simulation is run under the at least one state condition.

7. The method of claim 5, wherein the at least one state condition is at least one of an ambient pressure of the body of 1 bar or at least one force acting radially and/or axially on at least one part of the body.

8. The method of claim 1, wherein the threshold value is a fixed value.

9. The method of claim 8, further comprising obtaining the fixed value from a fractographic analysis of a plurality of sample containers.

10. The method of claim 8, wherein the fixed value is between 50 MPa and 300 MPa.

11. The method of claim 8, wherein the fixed value is a tensile stress of 150 MPa or a compressive stress of -500 MPa.

12. The method of claim 1, wherein at the least one stress parameter comprises a plurality of stress parameters.

13. The method of claim 12, wherein the plurality of stress parameters comprises a first stress parameter that is a tensile stress and a second stress parameter that is a compressive stress under a same state condition of axial load applied to the container at a breaking limit.

14. The method of claim 1, wherein providing the marking element comprises graving the marking element into an outer surface of the body.

15. The method of claim 14, wherein the marking element comprises a data code comprising at least one of dot-like elements or line-like elements.

16. The method of claim 14, wherein the marking element is graved into the body by a laser.

17. The method of claim 1, wherein identifying the location comprises evaluating the simulation result of the body and identifying at least one area where the at least one stress parameter has an averaged value over that at least one area that is less than the threshold value and choosing the location such that the location is at least partly within the at least one area.

18. The method of claim 1, wherein the threshold value is the sum of the mean value and 400 % or less of the absolute value of the mean value.

19. The method of claim 1, wherein the at least one stress parameter of the body has a value less than or equal to 90% of the threshold value.

20. The method of claim 1, wherein the marking element is provided on a bottom of the body.
